(19) United States
(12) Patent Application Publication
(10) Pub. No.: US 2006/0092535 A1
(43) Pub. Date: May 4, 2006

(54) Carbon fiber reinforced composite mirror and method of making the same

(76) Inventor: Robert Carl Romeo, Tucson, AZ (US)

Correspondence Address: ROSENBERG, KLEIN & LEE, 3458 ELLICOTT CENTER DRIVE-SUITE 101, ELLICOTT CITY, MD, 21043, US

(21) Appl. No.: 10/979,229

(22) Filed: Nov. 3, 2004

(51) Int. Cl. G02B 5/08; G02B 7/182

(52) U.S. Cl. 359/883; 359/838

(57) ABSTRACT

A carbon fiber reinforced composite mirror (100) is provided and includes a core layer (140) of carbon fiber composite material sandwiched between a front shell (120) and a rear shell (110). The front shell (120) and rear shell (110) are both formed of carbon fiber composite material. A reflective layer (130) is adhered to the outer surface of shell (120) and the mirror (100) may be mounted on a support structure (12) for use in optical display systems.

### BACKGROUND OF THE INVENTION

1. Field of the Invention

The subject invention relates to carbon fiber reinforced composite mirrors and methods of making the same. The carbon fiber reinforced composite mirrors are utilized in large scale optical systems, such as sophisticated computer simulation systems. In particular, the present invention directs itself to a composite mirror being formed from layers of cured carbon fiber composite tape. More particularly, this invention directs itself to composite mirrors having a carbon fiber reinforced plastic core sandwiched between two shells of cured carbon fiber composite tape.

Further, the individual shells are formed by layering the carbon fiber composite tape such that individual strands of carbon fiber of each layer are angularly displaced from the carbon fiber strands in adjacent layers in order to obtain uniform stiffness properties in the laminated structure. Additionally, this invention directs itself to a composite mirror having a reflective mirror surface coated thereon following uniform application of an epoxy resin to the outer surface of the frontmost shell.

2. Prior Art

Mirrors for large scale display systems are well-known in the prior art. However, such mirrors are generally made from a glass material coated with a reflective layer. Standard glass mirrors, however, are extremely fragile, are relatively heavy, and, when dealing with the optical accuracy necessary for display systems, are difficult to produce.

The system of the subject Patent Application provides carbon fiber reinforced plastic composite mirrors for display systems. The mirrors of the subject invention utilize a carbon fiber composite core sandwiched between layers of cured carbon fiber plastic composite tape. The carbon fiber composite mirrors are approximately 4 to 5 times lighter than standard glass mirrors and can withstand considerable stress and strain without cracking or breaking. The carbon fiber composite mirrors are easy to handle, install and support and are far easier to produce than standard glass mirrors.

Standard glass mirrors for optical systems require a great deal of polishing, grinding, and cleaning in order to obtain acceptable levels of optical accuracy. The method of forming carbon fiber reinforced plastic composite mirrors utilizes a “surface transfer” or “replication” process, which requires no grinding or polishing in order to achieve accurate optical mirror surfaces. The only polishing or cleaning takes place on the mold itself and, once completed, approximately 60 or more shells for the mirrors can be produced before another polishing is required.

Further, the carbon composite materials exhibit a unique ability to maintain their shape under rather severe loads, as required in modern flight simulator systems. The specific stiffness, and density characteristics of carbon fiber composites is approximately three times that of aluminum, thus making them ideal for the dynamic conditions of simulator systems. Further, because of the lightweight nature and high stiffness of the composite simulator mirrors, the mirrors require relatively small support systems in order to support them, thus reducing the weight of the entire simulator system.

Display systems, such as flight simulator systems, require large mirror surfaces. For example, the Blackhawk Helicopter simulator system requires a mirror with a diameter of 25 feet, which is impractical to produce as a single piece. Glass mirrors presently used for the Blackhawk Helicopter simulator system currently overlap one another, causing a clearly defined seam between the mirrors, thus creating undesirable optical effects. The composite mirrors of the present invention, however, can be butted next to one another easily and with no concern of fracturing or damaging the edges of the mirror panels, thus producing a continuous optical surface.

In simulator systems, the radius of curvature of the mirror is of vital importance. Producing glass mirrors all having the same radius of curvature is particularly difficult. Composite mirrors of the present invention method and system, however, are produced using the same mold and are, therefore, highly accurate with respect to one another.

### SUMMARY OF THE INVENTION

The present invention provides for a carbon fiber reinforced composite mirror and a method for making the same. The carbon fiber reinforced composite mirrors are formed from an inner multi-cellular core of carbon fiber plastic composite material sandwiched between the layers of cured carbon fiber composite tape. A layer of epoxy resin is uniformly spread across the concave surface of the front shell and a reflective layer is coated thereon.

It is a principle objective of the subject carbon fiber reinforced composite mirror to provide a multi-cellular carbon fiber composite core sandwiched between front and rear shells formed from carbon fiber composite material.

It is a further objective of the subject carbon fiber reinforced composite mirror to provide a composite mirror adaptable for mounting on a frame structure.

It is a further objective of the subject invention to provide a method of forming carbon fiber reinforced composite mirrors wherein front and rear shells of carbon fiber composite material are formed by the curing layers of carbon fiber composite tape on a mold.

It is an important objective of the present invention to provide a method of forming carbon fiber reinforced composite mirrors where a layer of epoxy resin is applied to the concave surface of the front shell and spread evenly thereover through use of the molds.

### BRIEF DESCRIPTION OF THE DRAWINGS

FIG. 1 is a perspective view of the subject carbon fiber reinforced composite mirror mounted on a support structure;

FIG. 2 is a cross-sectional side view of the step of forming one of the carbon fiber composite shells;

FIG. 3 is a cross-sectional side view of a single shell carbon fiber reinforced plastic mirror;

FIG. 4 is a cut-away view of two layers of carbon fiber composite tape in the formation process;

FIG. 5 is a perspective view of an alternative embodiment of the carbon fiber reinforced plastic mirror; and,

FIG. 6 is a cross-sectional side view of the epoxy application step in the formation method.

### DESCRIPTION OF THE PREFERRED EMBODIMENTS

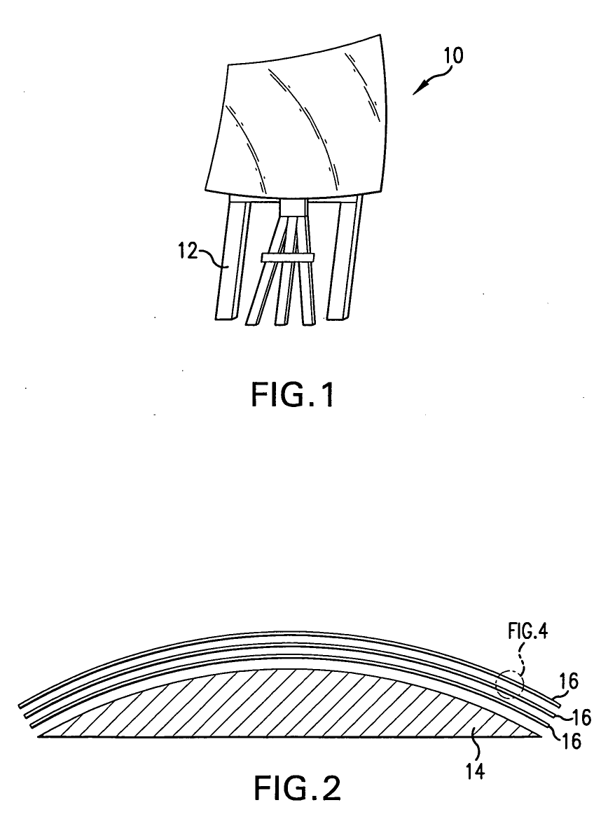

Referring now to FIG. 1, there is shown a carbon fiber reinforced composite mirror 10 mounted on a support structure 12. Carbon fiber reinforced plastic mirrors are generally produced as very large mirrors for simulation display systems. Carbon fiber composite mirrors, such as mirror 10 shown in FIG. 1, meet the strict military simulator system optical performance requirements for flight simulators. Additionally, carbon fiber composite mirrors are generally lighter than standard glass mirrors and are not subject to the general fragility of glass mirrors.

FIG. 2 illustrates the first step in the formation method of producing carbon fiber reinforced mirrors 10. A mold 14 is provided having the radius of curvature desired for the particular application of mirror 10. The mold 14 is polished and cleaned to the desired optical accuracy of the mirror 10. Following preparation of the mold 14, individual layers 16 of carbon fiber composite tape are positioned on the mold 14. FIG. 2 illustrates three such layers 16 being applied to the mold 14, however, any desired number of layers may be formed, depending upon the requirements of the mirror to be produced.

Although individual layers 16 of carbon fiber composite tape may be formed of any suitable material, preferably the carbon fiber composite tape is Fortafil 617, a product of Fortafil Fibers of Knoxville, Tenn. Fortafil 617 is a uni-directional carbon fiber prepreg tape. The material is a composite of proprietary epoxy resin with a curing temperature of 250° F. Fortafil 617 is a 33 million psi modulus carbon fiber. The material is produced as a 24 inch wide tape with a fiber-by-volume percentage of 65%.

Once the desired layers 16 have been applied to the mold 14, the carbon fiber composite tape layers are then cured through the application of heat in the temperature range of approximately 90° C. to 171° C. Additionally, the layers 16 are compressed against mold 14 during the curing process.

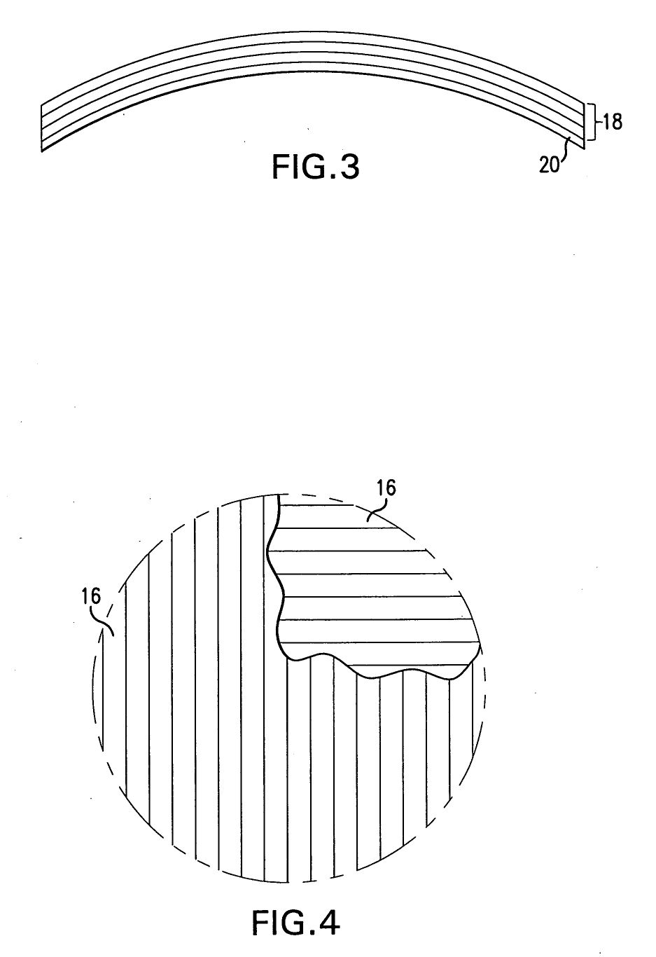

FIG. 3 illustrates the formation step of the mirror following the curing process. Once cured, the individual layers 16 form a thicker single layer 18 of the carbon fiber composite material in the shape of the mold 14. Once the layer 18 of carbon fiber composite material is removed from mold 14, a reflective layer 20 is then applied to the concave surface of the carbon fiber composite material 18. The reflective layer 20 may be a combination of aluminum and silicon dioxide, or any other suitable reflective material chosen for the particular applications of the mirror 10. Although any desired thickness of reflective layer 20 may be produced, the thickness of an aluminum layer is typically deposited to a thickness of approximately 1200 angstroms. A layer of silicon monoxide (SiO) would typically be approximately 500 angstroms thick.

The carbon fiber composite material used in the individual layers 16 is a uni-directional pre-impregnated tape having individual carbon fibers displaced from one another and running along the length of the tape positioned parallel each with respect to the other. These fibers are embedded in a plastic resin material. Each of the individual layers 16 has the individual carbon fibers of the carbon fiber composite material all positioned parallel each with respect to the other. However, in order to obtain uniform stiffness properties within the laminated layer 18, each individual layer 16 of the thicker layer 18 must be placed at different angles with respect to one another. As shown in FIG. 4, two adjacent layers have fibers which are positioned substantially orthogonal to one another, however, the fibers may be arranged at any non-equal angle with respect to one another.

The reflective layer 20 may be adhered to the carbon fiber composite layer 18 by any suitable adhesive, such as an epoxy resin.

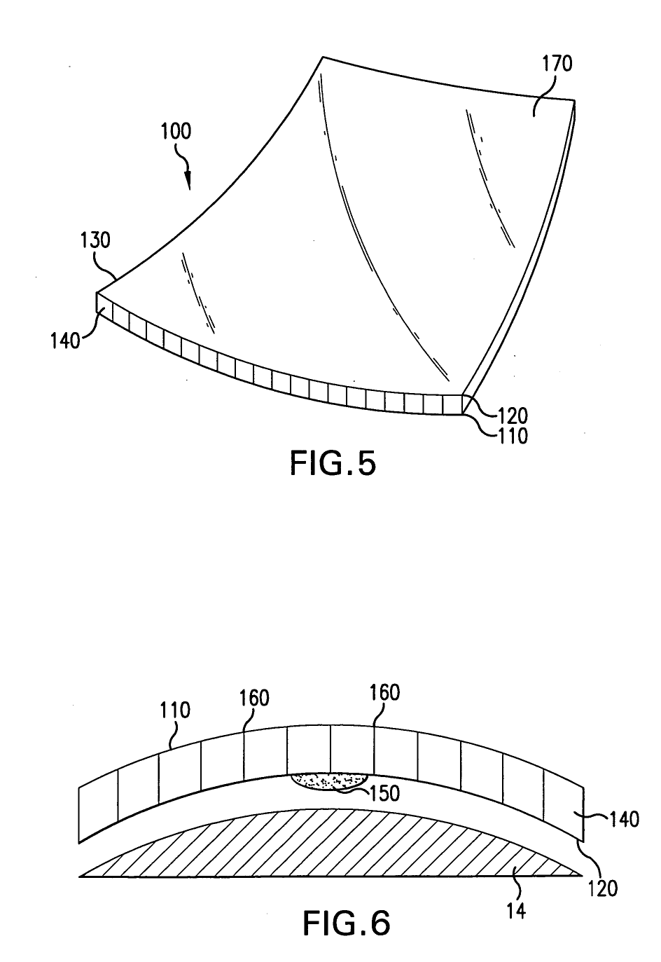

FIG. 5 illustrates an alternative embodiment wherein a multi-layered, or sandwiched, carbon fiber composite mirror is produced. The carbon fiber reinforced composite mirror 100 includes a core layer 140 sandwiched between a rear shell 110 and a front shell 120. A reflective layer 130 is formed on the upper surface of the front shell 120.

The rear shell 110 and the front shell 120 are formed in a similar manner to the carbon fiber reinforced structures illustrated in FIG. 2. Individual layers of carbon fiber composite tape 16 are placed on mold 14 and then cured through the application of heat and pressure in order to produce the shells 110 and 120 formed of the carbon fiber composite material.

The shell shown in FIG. 4 has a substantially circular shape and the mirrors in FIGS. 1 and 5 have substantially rectangular shapes. The mirrors may be produced in any desired shape and following the curing step of the front and rear shells 110 and 120, respectively, the two shells are trimmed to the desired shape using cutting templates, computer numerical control machining processes, or any other suitable trimming methods. If individual mirrors 10 or 100 are to be combined with other mirrors in order to produce a larger mirror, it is desired that the edges of the mirrors be trimmed using a highly accurate technique in order to reduce gaps between the mirrors in order to improve optical accuracy.

The core layer 140 is formed from the same type of carbon fiber composite material that forms individual layers 16. The core can be made to any desired thickness and should have a shape matching the front and rear shells 110 and 120. The core may be ground so as to fit snugly against the front and rear shells 120, 110 in order to provide proper support for the shells.

As shown in FIG. 6, the core layer 140 is cellular and includes multiple cells of the carbon fiber composite material separated from one another by beams or walls 160. Walls 160 may be positioned or angled in any desired fashion in order to produce cross-sectional regions of the carbon fiber composite material having any desired shape.

The core 140 is adhered to front shell 120 and rear shell 110 by any suitable adhesive, such as an epoxy resin. Once the core 140 has been positioned between the shells 110, 120, an epoxy resin 150 is applied to the front shell 120 so that the reflective layer 170 may then be applied to the mirror 100. The reflective layer 170 is similar to the reflective layer 20 of the mirror 10, shown in FIG. 3.

The thickness of epoxy layer 150 may vary depending upon the specific requirements of the mirror to be produced, however, the thickness typically ranges between 0.05 inches and 0.1 inches. The epoxy may be any suitable composition, however, Shell Epon 828 resin and a hardener supplied by Hexcel produced by the Hexcel Corporation of Stamford, Conn.

In the specific application of light simulator mirrors, the core layer 140 is a series of square cross-section carbon fiber reinforced plastic tubes glued between the top and bottom face sheets of the mirror. The thickness of the tubes, and hence the thickness and stiffness of the mirror, can vary depending on the figure tolerance requirements. In a preferred embodiment, the tubes are formed to be 1 inch long with a wall thickness of 0.05 inches, however, these figures can vary depending upon the specific requirements of the manufacturer. The tubes can be spaced closely together or spaced relatively far apart and separate from one another, depending upon the desired accuracy of the mirror during dynamic changes while in operation on the flight simulator platform. The accuracy of the mirror is increased with a closer spacing of the carbon fiber reinforced plastic tubes with respect to one another.

In order to apply the reflective layer 170, the surface mold 14 is cleaned in order to remove any residue from the formation process of the shells 110, 120 and a mold release material is applied to the polished surface of the mold 14. The release material may be a carnuba wax or polymer-based chemical release agent, which does not leave a visible residue on the mold surface.

The outer concave surface of the front shell is sanded and wiped thoroughly with a solvent in order to provide for proper adhesion with the epoxy resin 150. The resin 150 is dispensed in a pool or large drop in the center of the front shell 120, as shown in FIG. 6.

In order to properly distribute the epoxy resin 150 over the surface of the front shell 120, the front shell 120 is slowly brought into contact with the mold 14, allowing the epoxy resin 150 to spread evenly over the entire concave surface of the shell 120. The resin 150 is then allowed to cure according to the particular curing specifications of the material used.

Once the resin 150 is cured, the front shell 120 may be removed from the mold 14. The separation of the front shell 120 from the mold 14 is propagated through the injection of compressed air into the separation gap formed between the mirror and the mold. Once the front shell 120 has been separated from mold 14, excess epoxy 150 formed around the periphery of the front shell 120 may be removed.

Once the epoxy has been cured and the front shell 120 has been separated from the mold 14, the reflective layer 170 may then be applied.

The mirrors 10, 100 of the subject invention system may be used in large-scale simulation display systems. Presently, such systems utilize standard glass mirrors, which are extremely fragile and relatively heavy. The mirrors of the subject invention, however, are relatively lightweight and are also relatively easy to produce.

Mirrors 10, 100, being formed of carbon fiber plastic composite material, are approximately 4 to 5 times lighter than standard glass mirrors and can withstand considerable stress and strain without cracking or breaking. Additionally, the method of forming mirrors 10, 100 is far easier and less time consuming than the construction of large-scale standard glass mirrors. Further, standard glass mirrors for optical systems generally require a great deal of polishing, grinding, and cleaning in order to obtain acceptable levels of optical accuracy. The method of forming carbon fiber reinforced plastic composite mirrors described herein utilizes a “surface transfer” or “replication” process, which requires no grinding or polishing in order to achieve highly accurate optical mirror surfaces. The only polishing or cleaning takes place on the mold 14 itself and, once completed, approximately 60 or more individual shells, such as shells 110, 120 for mirrors 10, 100 can be produced before another polishing of the mold 14 is required.

The carbon composite materials utilized in the formation of the subject mirrors exhibit a rather unique ability to maintain their shape under severe loads, which is required in modern flight simulator systems. The specific stiffness and density characteristics of carbon fiber composites is approximately three times that of aluminum, thus making them ideal for the dynamic conditions of simulator systems. Further, because of the lightweight nature and high stiffness of the composite simulator mirrors, the mirrors require relatively small support systems, as shown in FIG. 1 of the Drawings, in order to support them, thus reducing the weight of the entire simulator system.

Display systems, such as flight simulator systems, require large mirror surfaces. For example, the Blackhawk Helicopter simulator system requires a mirror having a diameter of approximately 25 feet, which is impractical to produce as a single piece mirror. The glass mirrors used in the Blackhawk Helicopter simulator system are formed separately and currently overlap one another, thus causing a clearly defined seam between the mirrors and creating undesirable optical effects. Composite mirrors 10, 100 of the present invention, however, can be shaped, cut, and then positioned next to one another easily and with no concern of fracturing or damaging the edges of the mirror panels, thus producing a continuous optical surface and minimizing undesirable optical effects.

In simulator systems, the radius of curvature of the mirror is of vital importance. Producing glass mirrors all having the same radius of curvature is particularly difficult. Composite mirrors of the present invention method and system, however, are all produced using the same mold and are, therefore, highly accurate with respect to one another.

As shown in FIG. 1, the mirror may be supported on a support structure, such as support structure 12. The mirror is preferably held in only three separate points. The advantage of using carbon fiber reinforced plastic mirrors is that the mirrors are light enough that they do not sag appreciably due to their own weight. This means that the mounting positions are not particularly critical and one can place the supports where they are most convenient, rather than where they most evenly distribute the weight of the mirror.

A concern is that the mounts can pivot freely on the back of the mirror facesheet so that no torque or moment will be applied to the mirror at any mount location. This is why the mirrors are held, preferably, at only three points rather than more mounting locations, as would be typical with a flight simulator mirror.

Although this invention has been described in connection with specific forms and embodiments thereof, it will be appreciated that various modifications other than those discussed above may be resorted to without departing from the spirit or scope of the invention. For example, functionally equivalent elements may be substituted for those specifically shown and described, proportional quantities of the elements shown and described may be varied, and in the formation method steps described, particular steps may be reversed or interposed, all without departing from the spirit or scope of the invention as defined in the appended Claims.

What is claimed is:

1. A method of forming carbon fiber reinforced composite mirrors comprising the steps of:
(a) establishing a mold;
(b) forming a layer of carbon fiber composite tape on said mold;
(c) curing said layer of carbon fiber composite tape;
(d) removing said layer of carbon fiber composite tape from said mold; and,
(e) coating said layer of carbon fiber composite tape with a reflective layer to form a carbon fiber reinforced composite mirror.

2. The method of forming carbon fiber reinforced composite mirrors as recited in claim 1 wherein said step of establishing said mold is followed by a step of polishing said mold.

3. The method of forming carbon fiber reinforced composite mirrors as recited in claim 1 wherein said step of curing said layer of said carbon fiber composite tape includes compressing said layer of said carbon fiber composite tape and said mold.

4. The method of forming carbon fiber reinforced composite mirrors as recited in claim 1 wherein said step of curing includes heating said layer of carbon fiber composite tape at a temperature in the range of 90° C. and 171° C.

5. The method of forming carbon fiber reinforced composite mirrors as recited in claim 1 wherein a plurality of layers of said carbon fiber composite tape are formed on said mold.

6. The method of forming carbon fiber reinforced composite mirrors as recited in claim 5 wherein each said layer of said carbon fiber composite tape is formed such that individual fibers of said carbon fiber composite tape are positioned substantially parallel each with respect to the other within said layer.

7. The method of forming carbon fiber reinforced composite mirrors as recited in claim 6 wherein said individual fibers of each said plurality of layers are angularly displaced each with respect to the other.

8. The method of forming carbon fiber reinforced composite mirrors as recited in claim 1 wherein step (e) includes coating said layer of carbon fiber composite tape with an adhesive layer and adhering said reflective layer to said adhesive layer.

9. A method of forming carbon fiber reinforced composite mirrors comprising the steps of:
(a) establishing a mold;
(b) forming a layer of carbon fiber composite tape on said mold;
(c) curing said layer of carbon fiber composite tape;
(d) removing said layer of carbon fiber composite tape from said mold to form a rear shell;
(e) repeating steps (a)-(c) and removing said layer of carbon fiber composite tape from said mold to form a front shell;
(f) sandwiching a multi-cellular core layer of carbon fiber composite material between said front and rear shells; and,
(g) coating a reflective layer on said front shell to form a carbon fiber reinforced composite mirror.

10. The method of forming carbon fiber reinforced composite mirrors as recited in claim 9 wherein said step (g) further includes the steps of:
(i) cleaning said mold;
(ii) applying a mold release material to said mold;
(iii) cleaning said front shell and applying an epoxy resin thereto;
(iv) pressing said front shell to said mold to evenly distribute said epoxy resin over said front shell;
(v) curing said epoxy resin;
(vi) separating said front shell from said mold;
(vii) trimming excess epoxy resin from a periphery of said front shell; and,
(viii) applying said reflective layer to said epoxy resin.

11. The method of forming carbon fiber reinforced composite mirrors as recited in claim 10 wherein step (vi) further includes rotating said front shell with respect to said mold.

12. The method of forming carbon fiber reinforced composite mirrors as recited in claim 10 wherein said step (vi) further includes injection of compressed air into a separation gap formed between said epoxy resin and said mold.

13. The method of forming carbon fiber reinforced composite mirrors as recited in claim 9 wherein said step of establishing said mold is followed by a step of polishing said mold.

14. The method of forming carbon fiber reinforced composite mirrors as recited in claim 9 wherein said steps of curing said rear shell and said front shell include compressing said rear shell and said front shell, respectively, against said mold.

15. The carbon fiber reinforced composite mirror as recited in claim 9 wherein said steps of curing said front and rear shells include heating said front and rear shells at a temperature in the range of 90° C. and 171° C.

16. The method of forming carbon fiber reinforced composite mirrors as recited in claim 9 wherein each of said front and rear shells is formed of a plurality of layers of said carbon fiber composite tape formed on said mold.

17. The method of forming carbon fiber reinforced composite mirrors as recited in claim 16 wherein each said layer of said carbon fiber composite tape of said rear and front shells is formed such that individual fibers of said carbon fiber composite tape are positioned substantially parallel each with respect to the other within said layer.

18. The method of forming carbon fiber reinforced composite mirrors as recited in claim 17 wherein said individual fibers of each said plurality of layers are angularly displaced each with respect to the other.

19. A carbon fiber reinforced composite mirror comprising:
front and rear shells formed from carbon fiber composite material;
a multi-cellular carbon fiber composite core sandwiched between said front and rear shells; and,
a reflective layer formed on said front shell.

20. The carbon fiber reinforced composite mirror as recited in claim 19 wherein said reflective layer is formed of aluminum and silicon dioxide.

21. The carbon fiber reinforced composite mirror as recited in claim 19 wherein layers of adhesive are formed on upper and lower surfaces of said core, said front and rear shells being adhered to said layers of adhesive.

22. The carbon fiber reinforced composite mirror as recited in claim 19 wherein a layer of epoxy resin is formed on an outer surface of said front shell, said reflective layer being adhered to said layer of epoxy resin.

23. The carbon fiber reinforced composite mirror as recited in claim 19 wherein said carbon fiber reinforced composite mirror is adapted for mounting on a frame structure.

24. The carbon fiber reinforced composite mirror as recited in claim 19 wherein each of said front and rear shells is formed from a plurality of layers of carbon fiber composite tape.

25. The carbon fiber reinforced composite mirror as recited in claim 24 wherein each said layer of said carbon fiber composite tape is formed such that individual fibers of said carbon fiber composite tape are positioned substantially parallel each with respect to the other within said layer.

26. The carbon fiber reinforced composite mirror as recited in claim 25 wherein said individual fibers of each said plurality of layers are angularly displaced each with respect to the other.
